(19) United States
(12) Patent Application Publication
(10) Pub. No.: US 2020/0083614 A1
(43) Pub. Date: Mar. 12, 2020

(54) Sector Antenna Systems and Methods for Providing High-Gain and High Side-Lobe Rejection

(71) Applicant: Mimosa Networks, Inc., Santa Clara, CA (US)

(72) Inventors: John Sanford, Elfin Forest, CA (US); Brian L. Hinman, Los Gatos, CA (US); Carlos Ramos, San Jose, CA (US); Syed Aon Mujtaba, Santa Clara, CA (US)

(21) Appl. No.: 16/563,365

(22) Filed: Sep. 6, 2019

Related U.S. Application Data
(60) Provisional application No. 62/729,905, filed on Sep. 11, 2018.

(51) Int. Cl. H01Q 21/00; H01Q 1/48; H01Q 1/22

(52) U.S. Cl. CPC H01Q 21/0006; H01Q 1/22; H01Q 1/48

(57) ABSTRACT

Sector antenna arrays and methods of use that provide high main-lobe gain and high side-lobe rejection over a wide range of operating frequencies are provided herein. The example sector antennas provide these outstanding performance and reliability features due to (1) a cross-section profile for the ground plane, (2) a corporate feed for the linear array of patch antennas, and (3) an optimized sub-assembly of parasitic elements for high bandwidth operation with low return-loss.

### CROSS REFERENCE TO RELATED APPLICATIONS

This application claims the benefit and priority of U.S. Provisional Application Ser. No. 62/729,905, filed on Sep. 11, 2018, which is hereby incorporated by reference herein including all references and appendices cited therein.

### FIELD OF THE INVENTION

The present disclosure pertains to sector antennas, and more specifically, but not by limitation to sector antenna systems and methods for providing high-gain and high side-lobe rejection.

### BACKGROUND OF THE INVENTION

Antennas are useful in radio frequency and wireless technologies. Radio frequency technology utilizes radio waves to transmit audio signals. Wireless technologies allow for transmission of data or information to other devices over distances. Antennas help facilitate the transmission of communication signals or data to one or more remote clients.

### SUMMARY

In one aspect, the present disclosure is directed to a sector antenna system, comprising: a linear antenna array for the sector antenna, configured to implement slant 45-degree polarizations, to exploit beamforming gain, the linear antenna array comprising a plurality of patch antenna elements that are connected through a corporate feed, the linear antenna array located on a printed circuit board (PCB) of the sector antenna, each of the plurality of patch antenna elements having bi-level parasitic patch element assemblies of varying diameter discs, for high bandwidth operation with low return-loss, the PCB having two layers comprising the corporate feed and a ground plane, the two layers separated by a dielectric substrate, with chokes disposed on opposing sides of the PCB for high side-lobe rejection; and the ground plane having a cross-section profile configured in such a way as to support the linear antenna array on the PCB, in order to increase main-lobe gain and side-lobe rejection.

In another aspect, the present disclosure is directed to a sector antenna system comprising: a linear antenna array for the sector antenna, configured to implement slant 45-degree polarizations, to exploit beamforming gain, the linear antenna array comprising a plurality of patch antenna elements that are connected through a corporate feed, the linear antenna array located on a printed circuit board (PCB) of the sector antenna, each of the plurality of patch antenna elements having parasitic patch element assemblies, the PCB having two layers comprising the corporate feed and a ground plane, the two layers being separated by a dielectric substrate, with chokes disposed on opposing sides of the PCB for high side-lobe rejection; and the ground plane having a cross-section profile configured in such a way as to support the linear antenna array on the PCB, in order to increase main-lobe gain and side-lobe rejection.

In another aspect, the present disclosure is directed to a linear array for a sector antenna comprising: a plurality of patch antenna elements that are connected through a corporate feed and are arranged for high antenna gain, the linear antenna array located on a printed circuit board (PCB) of the sector antenna, each of the plurality of patch antenna elements having parasitic patch element assemblies, the PCB having two layers comprising the corporate feed and a ground plane, the two layers being separated by a dielectric substrate, with chokes disposed on opposing sides of the PCB for high side-lobe rejection.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1A are top views of example printed circuit boards for sector antennas, in accordance with the present disclosure. FIG. 1B are back views of example printed circuit boards for sector antennas, in accordance with the present disclosure.

FIG. 2A is a top view of an array of an example two-port sector antenna. FIG. 2B is a top view of an array of an example four-port sector antenna.

FIG. 3 is a top side view of an array of an example four-port sector antenna.

FIG. 4 provides partial perspective views of a polymeric radome for a sector antenna, in accordance with the present disclosure.

FIGS. 5A and 5B depict top down cross sectional schematic diagrams of example two-port and four-port sector antennas, respectively.

FIGS. 6A and 6B provide top down cross sectional views of an example sector antenna, in accordance with the present disclosure.

FIGS. 7A, 7B and 7C are top, side and bottom cross sectional views, respectively, of an example ground plane (base). FIG. 7D is a cross sectional view of one end of a ground plane. FIG. 7E is a perspective cross sectional view of a ground plane.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

High-gain antennas are desirable for a wide range of applications, since higher gain helps improve radio frequency (RF) or wireless link performance and reliability. Antenna gain can be increased by reducing the beamwidth in either the elevation plane (also referred to as the vertical plane), the azimuth plane (also referred to as the horizontal plane), or both planes. In other words, the narrower the beamwidth, the higher the gain.

In addition to antenna gain, another aspect of desirable antenna performance is “sidelobe rejection.” High sidelobe rejection allows the antenna to suppress or reject RF energy coming from non-desirable directions, thereby reducing noise and interference coming into the antenna.

An ideal antenna would be one that has high gain in the desired direction, minimal gain in the non-desirable direction, and sufficiently broad coverage in the azimuth plane.

High-gain antennas tend to come in three physical forms: (a) sectors, (b) horns, or (c) parabolic dishes. Access Point (or base station) antennas for Fixed Wireless Access (FWA) applications tend to use either sector antennas or horn antennas, since radiation patterns from the access point need to cover a broad enough angle in the azimuth plane. To this end, beamwidth of sector antennas in the azimuth plane is typically between 40 degrees and 120 degrees, whereas the beamwidth in the elevation plane is expected to much less (typically less than 10 degrees). If the azimuth bandwidth is too narrow, this increases the cost of network deployment, since more antennas are required at the tower or cell site to provide coverage at 360 degrees. Horn antennas, on the other hand, tend to have comparable beamwidths in both the azimuth and elevation planes, making them less efficient in spanning a large surface area in the azimuth/horizontal plane. However, horn antennas typically have better sidelobe rejection compared to sector antennas.

The present disclosure provides innovative systems and methods of sector antennas that provide high main-lobe gain and high side-lobe rejection over a wide range of operating frequencies. The sector antennas provided in the present disclosure provides these outstanding performance features thanks to (1) a cross-section profile for the ground plane, (2) a corporate feed for the linear array of patch antennas, and (3) an optimized sub-assembly of parasitic elements for high bandwidth operation with low return-loss. These sector antennas are designed to operate over the entire spectrum of 4.9 GHz to 6.4 GHz.

The present disclosure further provides sector antenna designs that achieve a high-gain directional radiation pattern over a wide frequency range of operation, are dual-polarized for maximum spectral efficiency, and employ a linear array within each polarization to exploit beamforming gain. Exemplary sector antenna designs described later herein include both the two-port sector antenna (also known as the two-port model) and the four-port sector antenna (also known as the four-port model). The two-port sector antenna can work well with third party radios, whereas the four-port sector antenna is intended to work with the Mimosa A5c proprietary access point (AP). The linear array of the sector antenna designs implements slant 45-degree polarizations by means of patch antenna elements that are connected through a corporate feed network. “Slant 45-degree polarization” means that one polarization is +45 degrees with respect to the vertical axis, and the other polarization is −45 degrees with respect to the vertical axis. Furthermore, each patch element has bi-level parasitic elements of varying diameter discs, optimally spaced for antenna performance.

Sector antennas can be formed using a vertical array of antenna elements placed over a metallic ground plane. The resulting antennas, often using two polarizations, have a relatively narrow elevation beam-width, while maintaining the azimuthal beam-width as 60, 90, or 120 degrees, typically.

Physical antenna gain is often achieved by arraying a set of antenna elements together, increasing the directionality of the array. The tradeoff of employing antenna arrays is limiting the directionality to a more narrow angular range. As a general observation, humans tend to live and work within a narrow elevation angle relative to the surface of the earth. Thus, it is often practical to create vertical arrays of antenna elements, which has the effect of increasing the gain of the array, while reducing the elevation beam-width. Cellular antenna panels, as an example, have been designed as arrays of vertical elements for many years.

Also, outdoor Wi-Fi is less popular than indoor Wi-Fi today. Typical use cases include Wi-Fi and Wi-Fi-derived radios for fixed access, and Wi-Fi access points in large venue and hospitality applications. In the latter case, the products deployed are often weatherized versions of those found in indoor applications.

The design of the exemplary sector antennas in the present disclosure are based on a vertical array to achieve a specified beamwidth in the elevation plane, and hence obtain high antenna gain. The example sector antennas are typically mounted on a support structure such as a pole such as to transmit signals over long distances to remote clients. With the help of these sector antennas, one can achieve superior data rates and speeds.

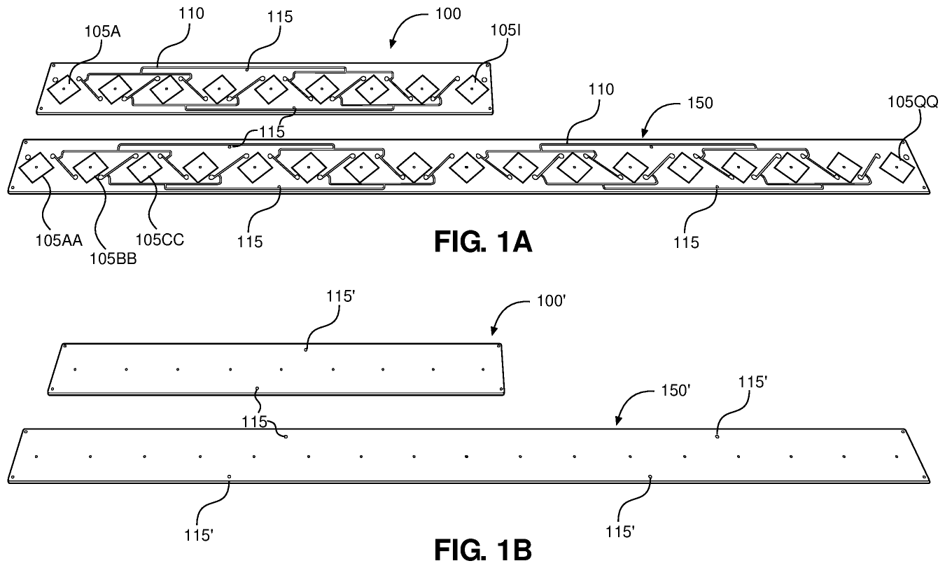

FIG. 1A depict top views of two example printed circuit boards for two sector antennas, in accordance with the present disclosure. Specifically, a printed circuit board (PCB) 100 for the two-port sector antenna (two-port model) is shown. Also, a printed circuit board 150 for four-port sector antenna (four-port model) is shown.

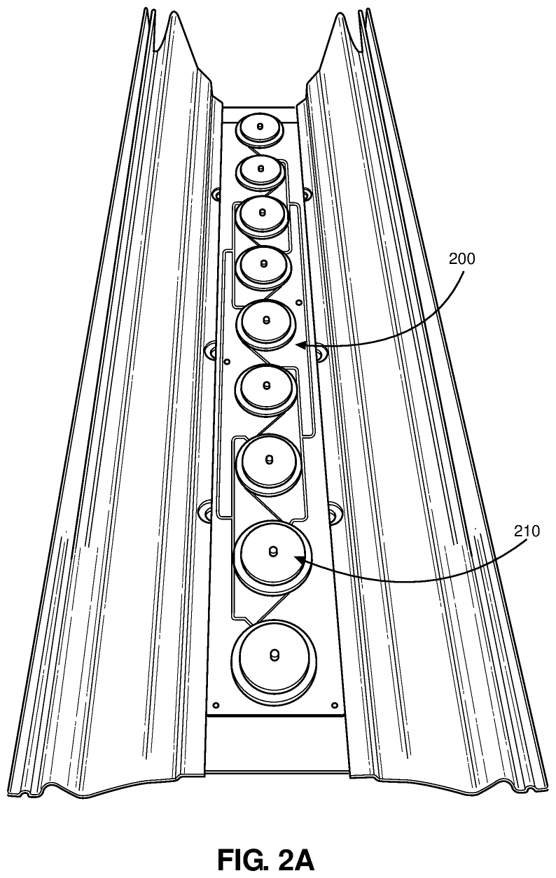

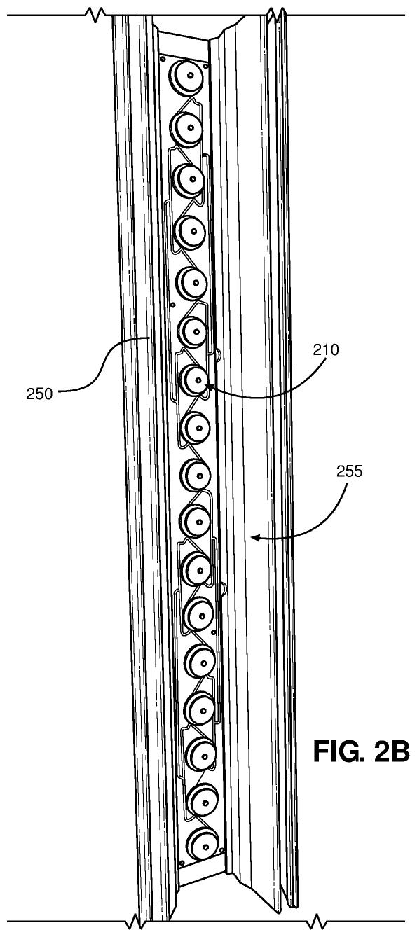

The two-port model design comprises a linear array of nine patch elements 105A-I corresponding with nine parasitic patch elements assemblies. An exemplary parasitic patch element assembly in a sector antenna is depicted as element 210 in FIG. 2A, which will be discussed later herein. For both the two-port model and the four-port model design, the PCB consists of two layers, namely, the top layer (the corporate feed), and the bottom layer (the ground plane). Both layers of the PCB are separated by a dielectric substrate.

In some embodiments, the elements of the antennas are arrayed using a fixed network of interconnect. In one embodiment, the fixed network of interconnect comprises a corporate feed where the lines connecting the elements receive signals at approximately the same time. Also, in some embodiments antenna elements can be configured in-phase. In general, a vertical array of elements is pointed perpendicularly to a reference plane, such as the horizon. When wire lengths interconnecting elements (such as in a corporate feed) are equal, there is in-phase alignment of signals received from near the horizon, which gives rise to constructive interference at a terminal end of the corporate feed.

In some embodiments according to the present disclosure, a series of antenna elements are connected in a linear array. This allows for a higher antenna gain by narrowing the reception pattern in the angle common to the linear array. A series fed array provides for a narrow physical design, as the connection between the elements is along the center line of the array. However, a series fed array suffers from a strong frequency dependency with respect to a far-field response. Thus, many linear antenna arrays utilize the corporate feed, whereby the elements are fed with a hierarchy of traces intended to equalize the path lengths.

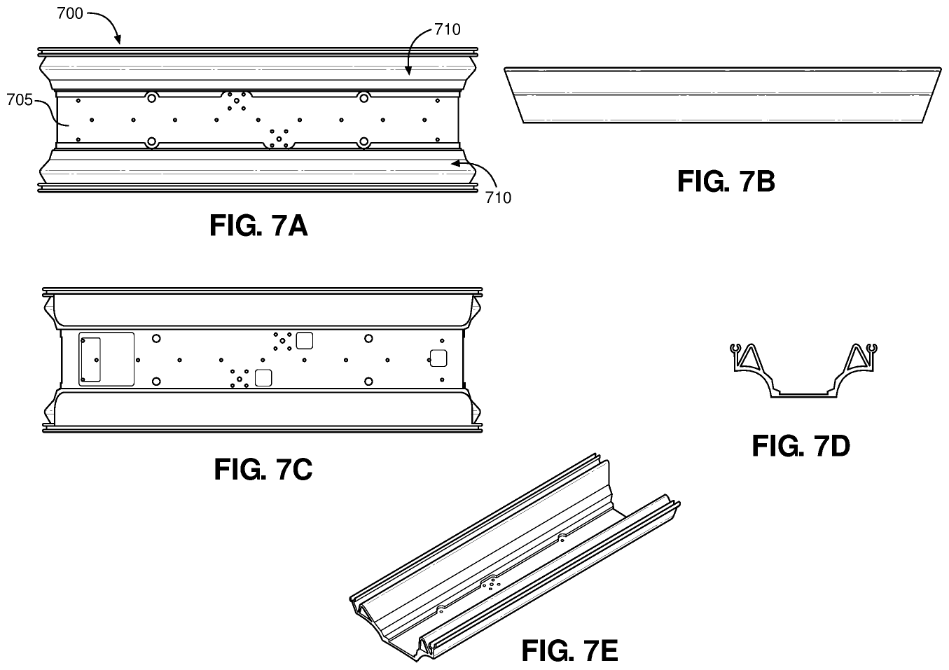

Each of the antenna arrays of the sector antennas consists of individual antenna patch elements, arranged vertically, connected through the corporate feed. The patch antenna array and corporate fed are designed on the PCB. The corporate feed layer of the PCB includes a corporate feed network 110 that is located on a surface of the PCB and is electrically coupled to the PCB. Furthermore, a plurality of feed points 115 is located on the PCB. The antenna elements 105A-I for the two-port model are linearly arrayed through the corporate feed in such a way that the antenna gain of the antenna arrays is increased while the elevation beam-width produced by the antenna arrays is reduced. The antenna elements 105A-I are generally placed over a metallic ground plane, which has the effect of creating directivity. The ground plane and its importance to the sector antennas will be described in greater detail in reference to FIG. 7, as provided below.

Each patch element within the linear array of the sector antenna, for both the two-port and four-port models, is dual polarized at −45 degree and +45 degree polarizations. One example of the +45-degree polarization is the copper PCB trace from the corporate feed network 110, entering the patch element (such as the patch element 105A in FIG. 1) at a 45-degree angle with respect to the vertical or the horizontal axis. One example of the −45-degree polarization is the copper PCB trace from the corporate feed network 110, entering the patch element (such as the patch element 105A in FIG. 1) at a negative 45-degree angle with respect to the vertical or the horizontal axis. Also, each patch element within the linear array of the sector antenna, for both the two-port and four-port models, is fed using the corporate feed to provide a wide bandwidth of operation.

The four-port model is similar to the two-port model in certain aspects, but notably, the four-port model comprises a linear array of seventeen patch elements 105AA-QQ (instead of the nine patch elements 105A-I of the two-port model), corresponding with seventeen parasitic patch elements assemblies. An exemplary parasitic patch element assembly in a sector antenna is shown as element 210 in FIG. 2A, which will be discussed later herein. The PCB for the four-port model 150 with its corporate feed network 110 and a plurality of feed points 115 is also illustrated in FIG. 1A.

FIG. 1B are back views of example printed circuit boards for the two-port and four-port sector antennas, in accordance with the present disclosure. The backsides of the PCBs have a copper ground plane. FIG. 1B also depicts the plurality of feed points 115 on the PCBs of the sector antennas.

FIG. 2A is a top view of an array 200 of a two-port sector antenna, in accordance with the present disclosure. The array 200 comprises nine parasitic patch elements assemblies that correspond with the nine patch elements 105A-I on the PCB 100 in FIG. 1A. Parasitic patch element assemblies are placed above driven patch elements, which are typically mounted on a low-loss substrate over a ground plane.

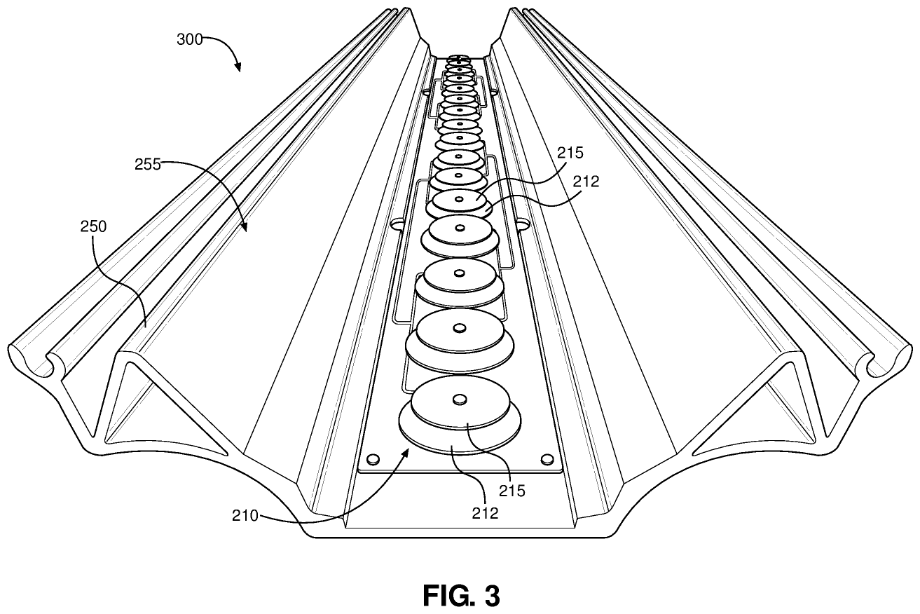

An exemplary parasitic patch element assembly is depicted 210. The parasitic elements improve the efficiency and bandwidth of a sector antenna. As shown in FIGS. 2A and 3, in some embodiments, the parasitic patch element assemblies may be optimally spaced for antenna performance, on the surface of the PCB.

FIG. 2B is a top view of an array 255 for a four-port sector antenna, in accordance with the present disclosure. The array 255 of the four-port sector antenna is similar to the array 200 of a two-port sector antenna in certain aspects, but notably the array 255 of the four-port sector antenna comprises seventeen parasitic patch elements assemblies (instead of the nine parasitic patch elements assemblies in the two-port model) that correspond with the seventeen patch elements 105AA-QQ on the PCB 150 in FIG. 1A.

FIG. 3 is a top side view of the array 250 of an example four-port sector antenna, in accordance with the present disclosure. The array 250 is linear and comprises seventeen parasitic patch elements assemblies that correspond with the seventeen patch elements 105AA-QQ on the PCB 150 in FIG. 1A. An exemplary parasitic patch assembly 210 of the array 255 is shown.

Each of the parasitic patch assemblies, for both the two-port model and the four-port model, are bi-level and are assembled at each printed circuit patch element, and electrically shorted to each PCB patch element, to improve the beamwidth and bandwidth performance. Each of the patch elements, for both the two-port model and the four-port model, has a bi-level parasitic patch assembly comprising two discs 212 and 215 having varying diameters, optimally spaced for antenna performance.

It should be noted that there is a specific metal geometry shape 255 unique for antenna performance as depicted in FIG. 3. As described in further detail regarding FIGS. 7A-E, in accordance with various embodiments of the present technology, the prescribed geometry of the metal or metalized structure supports an antenna PCB for a long and narrow sector antenna. The antenna PCB is located in the center groove of the structure, with a plurality of antenna elements approximately located in the middle of the PCB, and a choke disposed on opposing sides of the PCB. The chokes disposed on the opposing sides of the PCB act like speedbumps to antenna signals, which allow for high side-lobe rejection, and thus mitigate interference as much as possible. Thus, the sector antennas described herein are optimized towards the goal of maximizing gain and minimizing side lobes.

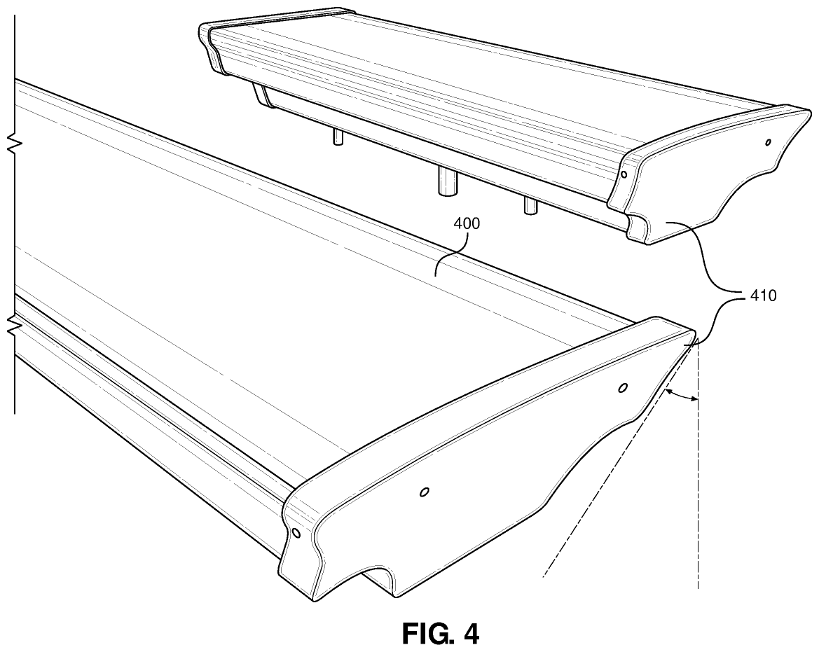

FIG. 4 provides partial perspective views of a polymeric radome 400 for a sector antenna, in accordance with the present disclosure. In some embodiments, the polymeric radome 400 include metal or metalized (not plastic) end caps 410 which are designed to be set at a prescribed angle and with a prescribed geometry, resulting in a low loss mechanical housing for the sector antenna. In one embodiment, these metal end caps may be tilted at a prescribed angel of approximately 20 degrees to address any interfering side lobes. Both the two-port and four-port sector antennas can incorporate the polymeric radome 400. The metal or metalized end caps 410 may be assembled to a metal base structure at the prescribed angle. The metal base structure is later described in greater detail in view of FIGS. 7A-7E.

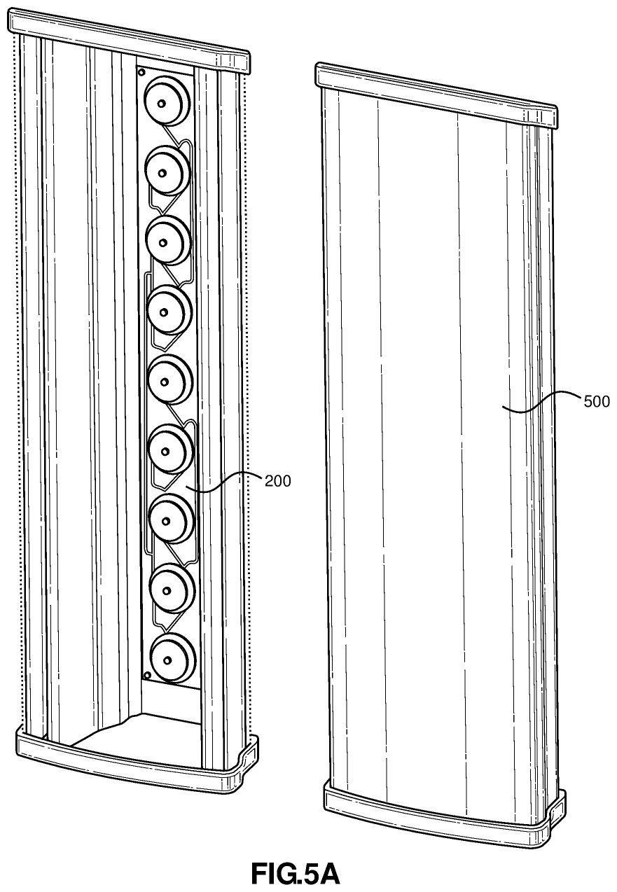

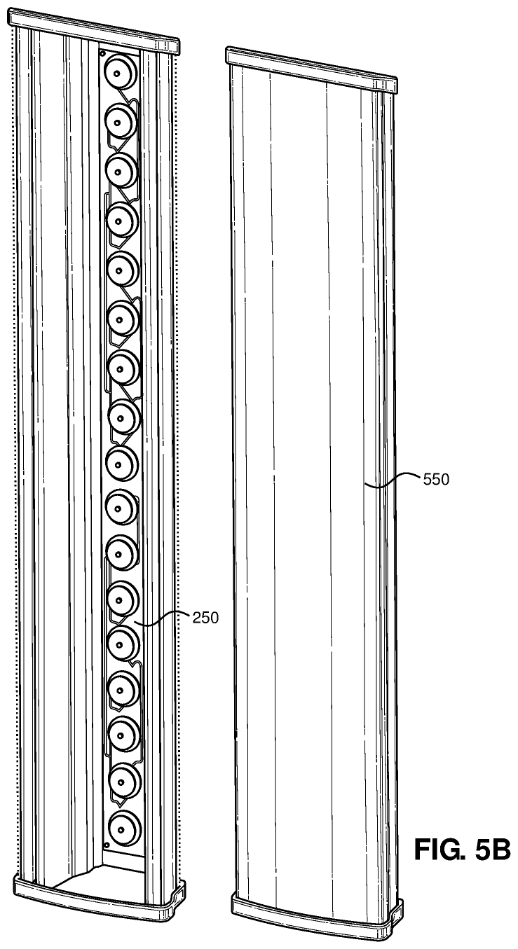

FIGS. 5A and 5B depict top down cross sectional schematic diagrams of example two-port and four-port sector antennas, respectively. Specifically, FIG. 5A shows an example two-port sector antenna with its array 200 of elements. The two-port sector antenna also includes a polymeric radome 500. Similarly, FIG. 5B shows the four-port sector antenna with its array 250 of elements. The four-port sector antenna also includes a polymeric radome 550.

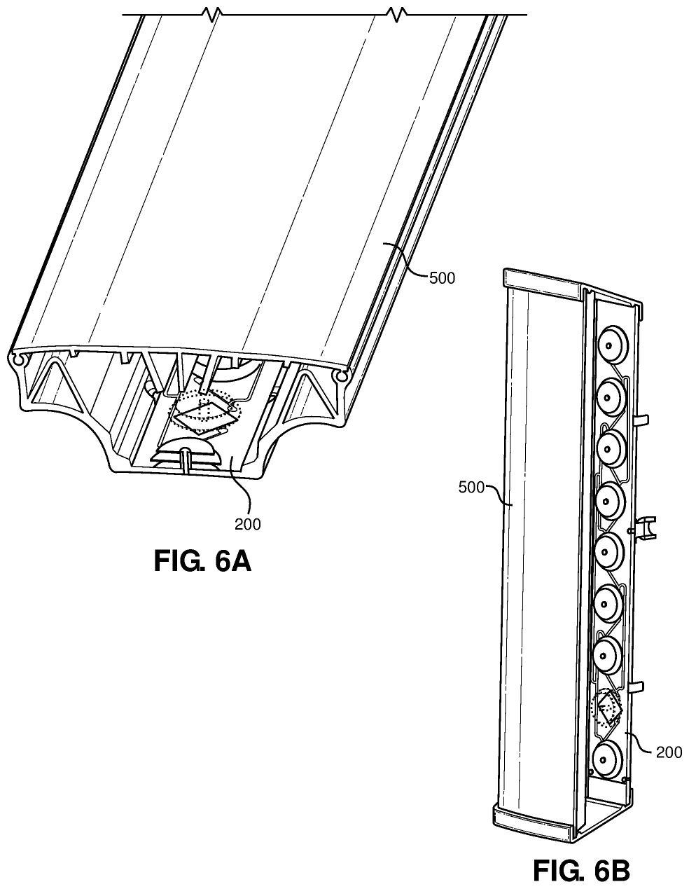

FIGS. 6A and 6B provide top down cross sectional views of an example sector antenna, in accordance with the present disclosure, having a polymeric radome 500 and its linear array. In some embodiments, a sector antenna is placed vertically on a pole, perpendicular to the horizontal axis. FIGS. 6A and 6B specifically shows the two-port sector antenna having a linear array 200 of nine elements, with the radome 500 covering the linear array 200 from outside environmental factors.

As mentioned earlier, the bottom layer of the PCB of the sector antenna is ground plane (base). That is, sector antennas can be formed using a vertical array of antenna elements placed over a metallic ground plane. FIGS. 7A, 7B and 7C are top, side and bottom cross sectional views, respectively, of an example ground plane (base). FIG. 7D is a cross sectional view of one end of a ground plane. FIG. 7E is a perspective cross sectional view of a ground plane.

In accordance with various embodiments of the present disclosure, both the two-port and four-port sector antennas incorporate a metal or metalized structure 700 with prescribed geometry, as depicted in FIGS. 7A-E. The structure enhances antenna performance, improves side-lobe rejection, and specifically improves the front-to-back ratio. This structure also serves as a “base” on which the PCB and parasitic patch assemblies are mounted. Thus, the cross-section of the ground plane as depicted in FIGS. 7A-E is key, since it has a profound impact on both the main-lobe gain and the side-lobe rejection. Also, any deviation from the cross-section profile for the ground plane as depicted in FIGS. 7A-E is likely to degrade antenna performance. The prescribed metal geometry as depicted in FIGS. 7A-E results in an antenna front-to-back ratio on both the two-port and four-port antennas that is equal to or greater than 43 dB.

As discussed earlier, and as depicted in FIGS. 7A-E, in accordance with various embodiments of the present technology, the prescribed geometry of the structure supports an antenna PCB for a long and narrow sector antenna. Such a design allows for sector antennas to be optimized towards the goal of maximizing gain and minimizing side lobes. In certain embodiments, the antenna PCB is located in the center groove 705 of the metal structure 700, with a plurality of antenna elements linearly arranged in the middle of the PCB and optimally spaced for antenna performance. Also, in some embodiments, chokes 710 are disposed on both sides of the PCB. The chokes 710 act like speedbumps to antenna signals, which allow for high side-lobe rejection, and thus mitigate interference as much as possible. In some embodiments, as shown in FIG. 7D, the chokes may have a U-shaped geometry.

The sector antennas described herein can be arranged in a variety of configurations. Sector antennas may be stacked one on top of another, or one sector antenna may be turned in a first direction while another sector antenna may be turned in a second direction to provide for broader coverage. Sector antennas may also be arranged side by side, which is advantageous for tower deployments given that it may be cheaper to deploy such antennas on towers.

The terminology used herein is for the purpose of describing particular embodiments only and is not intended to be necessarily limiting of the disclosure. As used herein, the singular forms “a,” “an” and the are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A sector antenna system, comprising:
a linear antenna array for the sector antenna, configured to implement slant 45-degree polarizations, to exploit beamforming gain, the linear antenna array comprising a plurality of patch antenna elements that are connected through a corporate feed, the linear antenna array located on a printed circuit board (PCB) of the sector antenna, each of the plurality of patch antenna elements having bi-level parasitic patch element assemblies of varying diameter discs, for high bandwidth operation with low return-loss, the PCB having two layers comprising the corporate feed and a ground plane, the two layers separated by a dielectric substrate, with chokes disposed on opposing sides of the PCB for high side-lobe rejection; and
the ground plane having a cross-section profile configured in such a way as to support the linear antenna array and the PCB, in order to increase main-lobe gain and side-lobe rejection.

2. The sector antenna system of claim 1, wherein a deviation from the cross-section profile for the ground plane will degrade antenna performance of the sector antenna.

3. The sector antenna system of claim 1, wherein the linear array is for a two-port sector antenna having nine patch antenna elements and nine corresponding bi-level parasitic patch element assemblies.

4. The sector antenna system of claim 1, wherein the linear array is for a four-port sector antenna having seventeen patch antenna elements and seventeen corresponding bi-level parasitic patch element assemblies.

5. The sector antenna system of claim 1, wherein each of the plurality of bi-level parasitic patch assemblies are assembled at each patch antenna element, and electrically shorted to each patch antenna element, to improve the beamwidth and bandwidth performance.

6. The sector antenna system of claim 1, wherein each of the plurality of patch antenna elements has a bi-level parasitic patch assembly comprising two discs having varying diameters, optimally spaced for antenna performance.

7. The sector antenna system of claim 1, wherein further comprising a polymeric radome to provide a low loss mechanical housing for the sector antenna.

8. The sector antenna system of claim 7, wherein the polymeric radome comprises metal or metalized end caps which are designed to be set at a prescribed angle.

9. The sector antenna system of claim 8, wherein the metal or metalized end caps of the polymeric radome may be tilted at a prescribed angle of approximately 20 degrees to address any interfering side lobes of the sector antenna.

10. The sector antenna system of claim 1, wherein the PCB and parasitic patch assemblies are mounted on a base of a metal or metalized structure, the structure having a prescribed geometry such as to enhance antenna performance, improve side-lobe rejection and improve front to back ratio.

11. The sector antenna system of claim 10, wherein the structure is configured geometrically such that the front to back ratio of the sector antenna is equal to or greater than 43 dB.

12. The sector antenna system of claim 1, wherein the chokes are configured in a U-shaped geometry.

13. A sector antenna system, comprising:
a linear antenna array for the sector antenna, configured to implement slant 45-degree polarizations, to exploit beamforming gain, the linear antenna array comprising a plurality of patch antenna elements that are connected through a corporate feed, the linear antenna array located on a printed circuit board (PCB) of the sector antenna, each of the plurality of patch antenna elements having parasitic patch element assemblies, the PCB having two layers comprising the corporate feed and a ground plane, the two layers being separated by a dielectric substrate, with chokes disposed on opposing sides of the PCB for high side-lobe rejection; and
the ground plane having a cross-section profile configured in such a way as to support the linear antenna array on the PCB, in order to increase main-lobe gain and side-lobe rejection.

14. A linear array for a sector antenna, comprising: a plurality of patch antenna elements that are connected through a corporate feed and are arranged for high antenna gain, the linear array located on a printed circuit board (PCB) of the sector antenna, each of the plurality of patch antenna elements having parasitic patch element assemblies, the PCB having two layers comprising the corporate feed and a ground plane, the two layers being separated by a dielectric substrate, with chokes disposed on opposing sides of the PCB for high side-lobe rejection.

15. The linear array of claim 14, wherein the linear array is for a two-port sector antenna having nine patch antenna elements and nine corresponding bi-level parasitic patch element assemblies.

16. The linear array of claim 14, wherein the linear array is for a four-port sector antenna having seventeen patch antenna elements and seventeen corresponding bi-level parasitic patch element assemblies.

17. The linear array of claim 14, wherein each of the plurality of bi-level parasitic patch assemblies are assembled at each patch element, and electrically shorted to each patch element, to improve the beamwidth and bandwidth performance.

18. The linear array of claim 14, wherein each of the plurality of patch antenna elements has a bi-level parasitic patch assembly comprising two discs having varying diameters, optimally spaced for antenna performance.
